(19) United States
(12) Patent Application Publication
(10) Pub. No.: US 2007/0094735 A1
(43) Pub. Date: Apr. 26, 2007

(54) METHOD TO CONSOLIDATE AND PRIORITIZE WEB APPLICATION VULNERABILITIES

(76) Inventors: Matthew L. Cohen, Irvine, CA (US); Dan Kuykendall, La Mirada, CA (US); JD Glaser, Irvine, CA (US)

Correspondence Address: CHARLES C.H. WU, 98 DISCOVERY, IRVINE, CA, 92618-3105, US

(21) Appl. No.: 11/553,450

(22) Filed: Oct. 26, 2006

Related U.S. Application Data
(60) Provisional application No. 60/730,427, filed on Oct. 26, 2005.

(51) Int. Cl. H04L 9/00; G06F 12/14; G06F 11/00; H04L 9/32; G06F 17/00; G06F 11/30; H04K 1/00; G06F 12/16; G06F 15/18; G08B 23/00

(52) U.S. Cl. 726/25; 726/1; 726/24; 713/188

(57) ABSTRACT

This invention relates to a method for consolidating and prioritizing web application vulnerabilities. Specifically, this invention relates to a method for consolidating the root causes for vulnerabilities in web applications, and then prioritizing the vulnerabilities to identify which should be remediated first.

### BACKGROUND OF THE INVENTION

1. Field of the Invention

This invention relates to a method for consolidating and prioritizing web application vulnerabilities. Specifically, this invention relates to a method for consolidating the root causes for vulnerabilities in web applications, and then prioritizing the vulnerabilities to identify which should be remediated first.

2. Description of the Related Art

During the last decade, there has been a massive shift towards web applications as a common platform for the access of corporate data. The security measures to prevent against the exploitation of web applications by hackers and other security breaches. Corporations are finding from both manual penetration tests and the use of automated scanners that they have large numbers of vulnerabilities. The dissemination of this data, however, does not help them remediate these vulnerabilities.

No current implementation exists today that helps people correlate web application vulnerabilities and determine both the root cause and the subsequent variations. This is an important determination because remediating application vulnerabilities is a very time consuming task due to the sheer volume of application code online and the huge content stored and presented by each application. An automated system to decrease time and effort in recognizing what are the most elementary items to remediate is important.

It is also the current industry practice to group vulnerabilities by classification. This means that for each application input, a classification of tests is run and the results listed. Then the next classification of tests is run, and the result listed. There is no correlation between these lists, and the user has no idea that vulnerabilities in two separate lists might be related. The user also has no idea which vulnerability to remediate first. In actuality there might be a root cause, which if remediated would correct the multiple dependents. An automated system is needed to correlate vulnerabilities between different classifications and present the user with a prioritized root cause hierarchy displaying two counts, the total of root causes, and the total of dependents.

Those skilled in the art of network security are familiar with network scanners. A network scanner is a technology that connects with many network servers and its ports, looking for network services with known vulnerabilities. This is done by using known attacks against the running services. U.S. Pat. No. 6,574,737 (the '737 patent) to Kingsford, et al. describes a computer network penetration test that discovers vulnerabilities in the network using a number of scan modules. The scan modules independently and simultaneously scan the network. A scan engine controller oversees the data fed and received from the scan modules which controls information sharing among the modules according to data records and configuration files that specify how a user-selected set of penetration objectives should be carried out. The '737 patent, however, does not operate at the application level and does not provide a method to isolate the root cause of or correlate vulnerabilities.

Web application scanners are also known. U.S. Pat. No. 6,615,259 to Nguyen, et al. describes a method and apparatus for scanning a web site in a distributed data processing system for problem determination. Web site scanning is initiated by a plurality of agents, wherein each of the plurality of agents is stationed at different locations in the distributed data processing system. Results of the scan are obtained from the plurality of agents. The results of the scan are analyzed to determine if a problem is associated with the web site. Once a problem or vulnerability is isolated by a web application scanner, similar to a network scanner, there is no means to determine its root cause or to correlate it's relationship to other vulnerabilities.

Other means currently exist for assessing the vulnerabilities in a system. For example, U.S. Pat. No. 7,013,395 to Swiler, et al. describes a computer system analysis tool and method that will allow for qualitative and quantitative assessment of security attributes and vulnerabilities in systems including computer networks. According to the invention, an attack graph is generated based on hypothesized capabilities of an adversary, network configuration information, and knowledge of the requirements for a successful attack. An attack graph generated in this fashion is then analyzed to determine high-risk attack paths and to provide insight into how to reduce network vulnerability.

While technologies that evaluate a site's known vulnerabilities have been in existence for some time, they provide only for the reporting of actual and potential vulnerabilities, with no means of identifying their root causes and correlate them based on relationships to other vulnerabilities.

### SUMMARY OF THE INVENTION

This invention relates to a method for identifying root causes of vulnerabilities from a list of vulnerability findings and consolidating that list of vulnerability findings into a prioritized remediation list so that remediation can occur in the most efficient manner possible. This is made possible by knowing the root cause.

A feature of the subject invention is the benefit derived from consolidating vulnerabilities by their root cause, as opposed to, or in addition to, the current industry practice of organizing vulnerabilities by classification. Consolidating vulnerabilities by root cause prevents the problem of having overlapping vulnerabilities that fall into multiple classifications, and instead provides the user with a smaller, discrete number of vulnerabilities to correct.

Another benefit derived from consolidating vulnerabilities by their root cause is that multiple dependent variations resulting from the root cause are also remediated. In other words, remediating the root cause also remediates the dependencies, thereby saving time, energy and resources. For example, in a given list of 100 vulnerability findings in either single or multiple categories, for a given web application input, using the existing methods, a developer would have to correct all 100 findings using multiple, and possibly up to 100 fixes because the developer would not know which of any of the vulnerabilities are dependent vs. independent. Using the proposed method of the subject invention, the user can identify and eliminate the root cause(s) of a vulnerability, which automatically corrects all dependencies, thereby saving a great deal of time and effort.

Another benefit derived from consolidating vulnerabilities by their root cause is that only the root cause and subsequent dependencies need be reported to the user. The current industry practice of organizing vulnerabilities by classification leads to a reporting of vulnerabilities in an unrelated manner, which does not provide the user with the necessary information to remediate the higher priority vulnerabilities first. For example, out of 100 industry acknowledged HIGH level vulnerabilities, which ones should be fixed first?

Another benefit derived from consolidating vulnerabilities by their root cause is that recommendations can be combined into a single comprehensive recommendation to be applied instead of multiple single fixes. This gives the developer more thorough information to develop a single comprehensive fix capable of solving multiple problems with a single correction instead of multiple corrections.

Another benefit derived from consolidating vulnerabilities by their root cause is that the root cause information can be added to 3^{rd} party bug tracking software so that related issues are properly grouped together and not reported as multiple separate findings. This greatly reduces the number of reported problems saving development and quality assurance teams time.

Another feature of the subject invention is that it will create an application remediation priority score to allow users to determine what vulnerabilities should be remediated first. The priority score will be based on several factors, including business impact, risk of data loss, risk of vulnerability and ease of access. A priority score will be created for each of the user's web applications and summarized on a prioritization report.

### BRIEF DESCRIPTION OF THE DRAWINGS

The foregoing will become more readily apparent by referring to the following detailed description and the figure drawings in which:

FIG. 1 presents a table to illustrate an example of a vulnerability consolidation report;

FIG. 2 presents a table to illustrate an example of a vulnerability prioritization report.

### DETAILED DESCRIPTION OF THE INVENTION

A. Definitions:

Resource—in very general terms, this is likely a file on a web server that would create a web page. It could also be a JavaScript link that creates a page. Strictly speaking, resources can be things other than web pages. It could also be a configuration file, or other type of file that does not serve content, but rather performs some other function. All the resource types we identify and catalog are listed below in the table.

Resource Attributes—these are the characteristics of a resource. For example, a resource (web page) may have some images, as well as content that comes from a database, and requires a cookie in order to browse to the page. This would create three attributes that we would catalog: images, a database connection and a cookie. Other attributes are collected as well (see table below).

Attack Vector—An attack vector is a path or means by which a hacker (or cracker) can use to deliver a payload for malicious outcome. Attack vectors enable hackers to exploit system and application vulnerabilities, including the human element. Server Attack vectors include URLs, GET, POST, Cookies, and HTTP Headers. User based attacks (i.e. client side scripting) include HTML, Javascript, Flash, PDFs and other client side executable languages.

Primary Identifier—An HTML page generated from raw HTML, or Java, JavaScript, AJAX, Net, PHP, SOAP or any other construction presented within an HTML Browser. Primary Identifiers can contain 0 thru infinite number of Secondary Identifiers.

EXAMPLES OF PRIMARY IDENTIFIERS

URL
HTML FILES
APPLICATION CONTENT
(E.G., PHP, ASP, JAVA, CFM, ETC.)
JAVASCRIPT
COMPRESSED FILES
ARCHIVE/BACKUP FILES (E.G., BAK)
LOG FILES
INCLUDE FILES

Secondary Identifier—An input property existing as a parameter within an HTML page. Examples are GET, POST or Cookie input parameters, Form field parameters, Cookies, and SQL input strings.

EXAMPLES OF SECONDARY IDENTIFIERS

URL/FORM PARAMETERS
GET PARAMETERS
POST PARAMETERS
COOKIES
FORM FIELDS
EMAIL ID
JAVASCRIPT FUNCTIONS
AUTHENTICATION INPUT POINTS
QUERY STRING INPUTS
(E.G., FOR A DATABASE)
HIDDEN FIELDS
COMMENTS
SCRIPTS
APPLETS/OBJECTS
AJAX FUNCTIONS
ALPHA-NUMERIC PARAMETERS

Vulnerability—these are the characteristics of a vulnerability. For example, a resource (web page) may have some images, as well as content that comes from a database, and requires a cookie in order to browse to the page. This would create three attributes that we would catalog: images, a database connection and a cookie. There are many attributes we collect, all are listed below in the table.

Vulnerability Listing—Existing vulnerability listings are simple lists of vulnerabilities found against an HTML input field. Each entry in the list represent a singular issue with no correlation to any other issue.

Root Cause—The determination of a single input vulnerability issue that may have multiple dependent variations. Fixing the root vulnerability cause also remediates the dependent vulnerability issues.

B. Vulnerability Consolidation Process

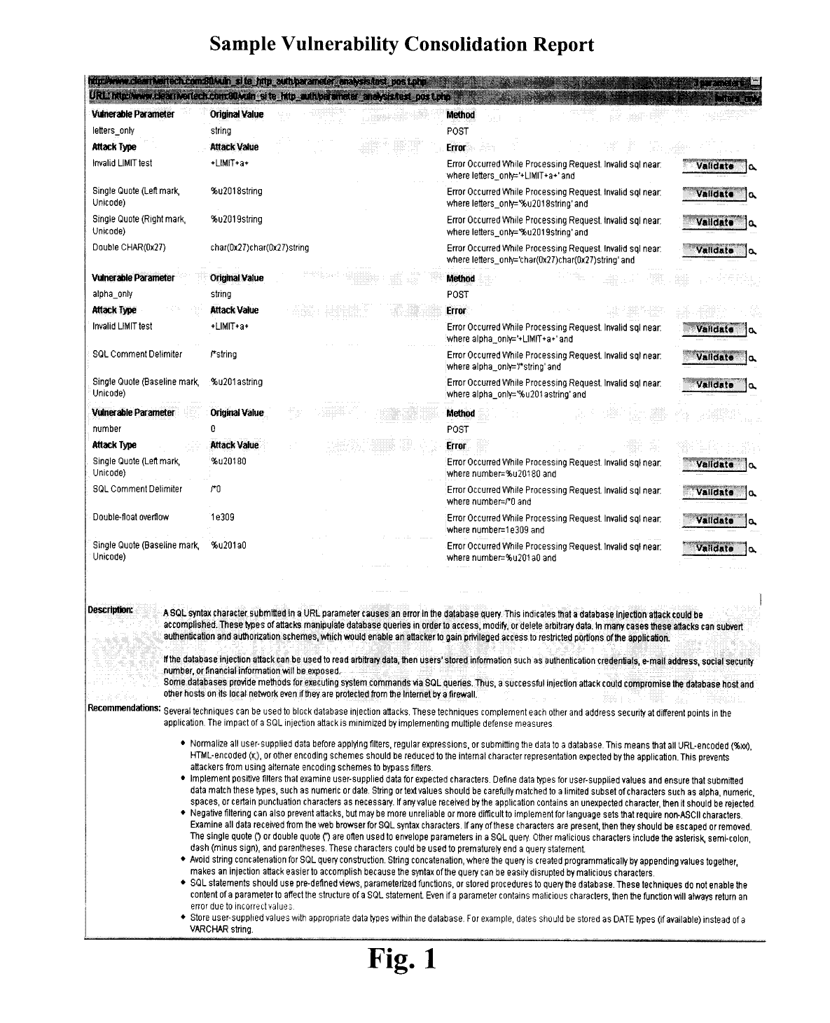

Vulnerability Consolidation is done by identifying a single point (root cause) from which many variations of attacks are related. This includes identifying first a primary identifier based on collected URL's, either queried from a database, data store file, or directly from a URL, cataloguing all the included secondary identifiers and then finally listing the dependent variations that can be remediated from a correctly implemented root filter. See FIG. 1 for a Sample Vulnerability Consolidation Report.

The process begins with the following:

1. Extract a primary identifier URL either from a database via ODBC SQL statement, retrieval from a static information store, or from a website, via HTTP request;

2. Determine and record whether or not the primary identifier contains one or more secondary identifiers (i.e. GET, POST or Cookie parameters);

3. Display secondary identifier within context of primary identifier;

4. Successful vulnerability attacks are filtered and displayed within context of secondary identifier, creating a nested hierarchy of vulnerabilities dependent upon the root secondary identifier;

5. Total the number of root causes, and total the number of dependent variations at the various layers.

C. Vulnerability Consolidation Calculation

Once the subject invention has catalogued all primary and secondary identifiers, a count is performed of all subsequent variations correlated to the key secondary identifier. For example:

http://www.acme.com/inputform.html?parameter1=abc&parameter2=123

http://www.acme.com/inputform.html?parameter1=cde&parameter2=345

http://www.acme.com/inputform.html?parameter1=fgh&parameter2=678

http://www.acme.com/displayform.html?parameter1=001

http://www.acme.com/displayform.html?parameter1=002

http://www.acme.com/displayform.html?parameter1=003

The primary vector http://www.acme.com/inputform.html includes two secondary vectors which are parameter1 and parameter2. The primary vector http://www.acme.com/displayform.html includes only one secondary vector which is parameter 1.

This gives us a total of 5 attack vectors to work with, along with some possible mixed vector attacks:

1. http://www.acme.com/inputform.html itself

2. parameter1 on http://www.acme.com/inputform.html

3. parameter2 on http://www.acme.com/inputform.html

4. http://www.acme.com/displayform.html itself

5. parameter1 on http://www.acme.com/displayform.html

Additionally, for each attack vector we generate a summary with an expandable list of dependent vulnerabilities based on variations of the identified root cause.

All successful attack vectors:

1. Have a root parameter with an attackable alpha-numeric input set;

2. Have zero to many subsequent variations of attacks then can be corrected if the root cause is properly corrected.

Reporting of web application vulnerabilities can include:

1. The ratio of root cause Attack Points to subsequent variations of dependent Attack Points;

2. The types of attackable content attributed to the root cause.

An application's total number of vulnerabilities is calculated based on the root of each attack point:

1. For each type of attack point, the total number variations present in the application can be treated in a combined fashion instead treating each in the traditional manner as independent and isolated separate events;

2. The sum of all root attack point represents the true total of remediation items.

D. Vulnerability Prioritization Process

After vulnerabilities are consolidated by their root cause, the next step is to prioritize them after taking into account specific factors for each of the user's web applications or websites. This enables the user to determine what vulnerabilities should be remediated first.

The prioritization report is prepared after taking the following factors into account for each of the user's web applications:

1. Application Business Impact. Security teams need to understand the importance of web applications to the company business and prioritize efforts to secure the most important sites. While some applications will have an obvious impact (E-Commerce sites, for example) others will have a less obvious, but no less important impact (inventory control systems that facilitate shipping, for example). This rating will be input by the security team based on considerations specific to its business. The invention will have a module to assist security teams in creating these ratings. This module will help profile the application and understand its business importance based on business factors such as transaction volume as a percentage of overall revenue, importance of 24/7 access, etc.;

2. Risk of Data Loss. Security teams need to consider the potential impact of fines and brand damage if customer data is lost in a breach. Sites that access databases containing personal and financial information need to be secured. This invention evaluates HTML source code, including both table names and the text used to describe user inputs, in order to determine the data that the application can access;

3. Risk of Vulnerability. Not all vulnerabilities are as easy to exploit as others. Some vulnerabilities, like cross-site scripting, can only be exploited when combined with successful social engineering and as such have less of an impact than a SQL Injection vulnerability that could expose an entire database. Some vulnerabilities are informational in nature and require significant time to exploit. This method categorizes the risk of each vulnerability into high, medium, low and informational;

4. Ease of Access. Some web applications are inherently more at risk than others. The most exposed website is obviously one that is accessible by hackers from remote locations directly over the Internet. While internal networks can be penetrated there can be no denying the fact that intranets have an additional layer of protection that public-facing sites do not enjoy. Authentication schemes also provide an additional layer of protection. This method will identify the websites that are available to remote users without authentication;

5. Priority. This method will create an application remediation priority score. The score will be based on factors including business impact, risk of data loss, risk of vulnerabilities and ease of access. This will be customizable by users to allow them to determine the importance of different variables in determining remediation priority;

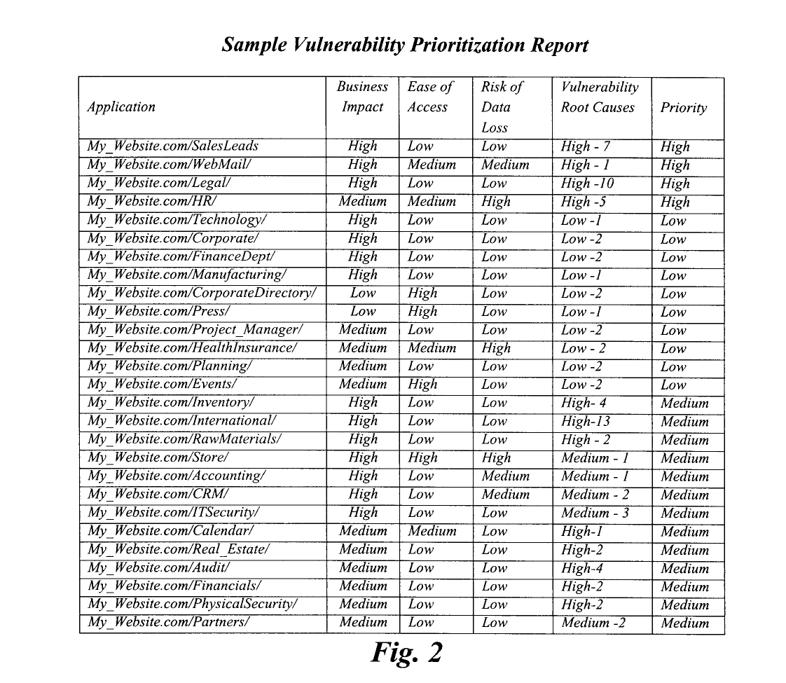

This method will include a vulnerability prioritization report that will summarize the user's applications and help security teams prioritize which applications to remediate first. FIG. 2 shows a Sample Prioritization Report. Other steps and aspects may be incorporated upon method revisions.

What is claimed is:

1. A method for consolidating and prioritizing a web application's vulnerabilities, via identification of a primary identifier and secondary identifiers, said primary identifier comprising an HTML page generated from any construction presented within an HTML browser (e.g., URL, HTML file, application content such as client side input sources, application source code files, compressed files, archived or backup files such as BAK, log files and include files), said secondary identifier comprising an input property existing as a parameter within an HTML page (e.g., URL/FORM parameters, GET parameters, POST parameters, cookies, form fields, email id., script functions, authentication input points, query string inputs such as for a database, hidden fields, comments, scripts, applets/objects, language functions and alpha-numeric parameters),
isolating a single or multiple input points into root cause (s) for each vulnerability from which vulnerability variations arise, described as vulnerability consolidation, which includes first identifying the primary identifier based on collected web application input sources, either queried from a database, read directly from application source code files, or directly from a URL on a website via HTTP or HTTPS,
cataloguing all the included secondary identifiers,
for each secondary identifier, run all categories of vulnerability attack classes,
for each secondary identifier, compile list of all successful attacks from all vulnerability categories,
for each secondary identifier, determine a root issue and it's subsequent dependents across all vulnerability categories,
for each secondary identifier, list the number of root causes and the number of subsequent dependencies from one or more vulnerability classes,
list a root recommendation that fixes the dependencies.

2. The method as claimed in claim 1, further comprising a vulnerability prioritization report listing each of user's web applications and which should be given priority with respect to remediating any vulnerabilities, said report containing the following categories: Application; Business Impact; Ease of Access, Risk of Data Loss; Vulnerability Root Causes; and Priority.

3. The method as claimed in claim 2, wherein said Business Impact is classified on a scale of low, medium or high.

4. The method as claimed in claim 2, wherein said Ease of Access is classified on a scale of low, medium or high.

5. The method as claimed in claim 2, wherein said Risk of Data Loss is classified on a scale of low, medium or high.

6. The method as claimed in claim 2, wherein said Vulnerability Root Causes is classified on a scale of low, medium or high.

7. The method as claimed in claim 2, wherein said Priority is classified on a scale of low, medium or high.

8. The method as claimed in claim 1, wherein said vulnerability consolidation comprises the following steps:
a. Extract a primary identifier URL either from a database, information store, or from a website;
b. Determine and record whether or not the primary identifier contains one or more secondary identifiers;
c. Display secondary identifier within the context of the primary identifier;
d. Successful vulnerability attacks are filtered and displayed within context of secondary identifier, creating a nested hierarchy of vulnerabilities dependent upon the root secondary identifier;
e. Total the number of root causes, and total the number of dependent variations at the various layers.

9. The method as claimed in claim 8, wherein said vulnerability consolidation is calculated using the following steps:
a. Once the subject invention has catalogued all primary and secondary identifiers, a count is performed of all subsequent variations correlated to the key secondary identifier, which identifies the number of attack vectors, or means by which a hacker can use to deliver a payload for malicious outcome;
b. for each attack vector a summary is generated with an expandable list of dependent vulnerabilities based on variations of the identified root cause;
c. each successful attack vector will have a root parameter with an attackable alpha-numeric input set and will have zero to many subsequent variations of attacks that will be corrected if the root cause is properly corrected;
d. For each type of attack point, the total number variations present in the application can be treated in a combined fashion instead treating each in the traditional manner as independent and isolated separate events;
e. a web application's total number of vulnerabilities is then calculated based on the total number of root attack points.

10. The method as claimed in claim 9, wherein said vulnerability consolidation can be reported based on:
a. the ratio of root cause Attack Points to subsequent variations of dependent Attack Points.
b. The types of attackable content attributed to the root cause.

11. The method as claimed in claim 10, wherein each of user's running web applications is prioritized with respect to remediating any vulnerabilities, the priority determined after accounting for the following factors:
a. Vulnerability Root Causes—Number of root causes of vulnerability in the web application and level of vulnerability;
b. Business Impact—Importance of the web application to the user's business;
c. Ease of Access—The ease of accessibility to the web application by others;
d. Risk of Data Loss—The risk of data loss within the web application due to existing vulnerabilities.
